(19) United States
(12) Patent Application Publication
(10) Pub. No.: US 2021/0306447 A1
(43) Pub. Date: Sep. 30, 2021

(54) Cell Phone Stand

(71) Applicant: Yona Lebovitz, Monroe, NY (US)

(72) Inventor: Yona Lebovitz, Monroe, NY (US)

(21) Appl. No.: 16/833,537

(22) Filed: Mar. 28, 2020

(51) Int. Cl. H04M 1/04; F16M 11/22

(52) U.S. Cl. CPC H04M 1/04; F16M 11/22

(57) ABSTRACT

The present invention is a cell phone stand to secure a cell phone with a metal frame which is smartly designed and incredibly strong, so it can withstand the weight cell-phone without any problems.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention relates to a stand. More specifically, the invention is a cell phone stand that can be utilized with a cell phone. The stand can accommodate various types of mobile phones in different sizes, and firmly keep them in place.

### Description of the Related Art

Mobile phone has become a necessary means of communications in today's industrial and commercial society, with which it can send and receive the message without day, thus helping us get latest information at any time. In addition, due to the popularity of mobile phones, we would take control of the timing in any appointment or business negotiation, and never lose any business opportunity just because of unavailability to contact in case of any unexpected event, for example, a traffic jam.

However, mobile phones now found in the market are different in size. It often causes problems in carrying and using them, especially when in the car. As there is no device to hold a mobile phone in the car, it is usually put at a place near the driver. By this way, it is not convenient for the driver to take, and there is also the possibility to get the mobile phone fallen down or hit during driving on rough road or in turning the direction, thus causing damage to the mobile phone.

However, to Applicant's knowledge, none of these prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

In order to solve the above problems, the present invention relates to a cell phone stand for supporting a phone or similar device in the upright position with an integrated cord holder.

The present invention provides a novel and improved cell phone protection case structure having a support frame.

According to yet another embodiment, the present invention provides typically the stand with cord holder built-in.

Another embodiment of the present invention is to provide a cell phone stand that is portable.

Numerous other embodiments are also possible.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is a top perspective view of a cell phone stand showing the new design.

FIG. 200 is a right bottom perspective view thereof.

FIG. 300 is a front elevational view thereof.

FIG. 400 is a rear elevational view of the present invention.

FIG. 500 is a top plan view thereof.

FIG. 600 is a bottom plan view thereof.

FIG. 700 is a right elevational view, a left elevational view being a mirror image thereof.

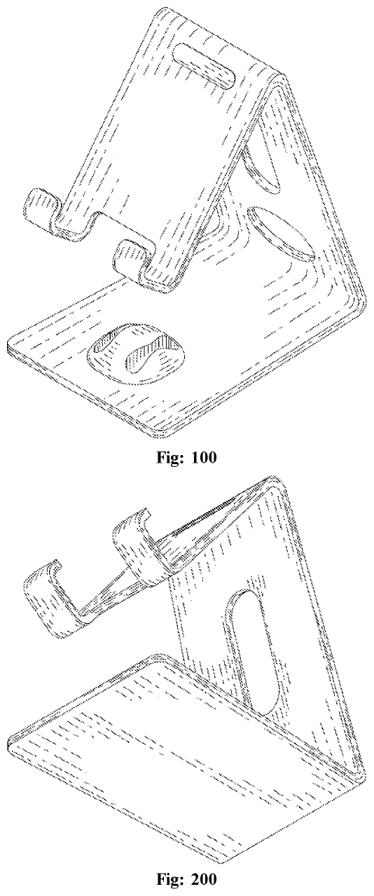

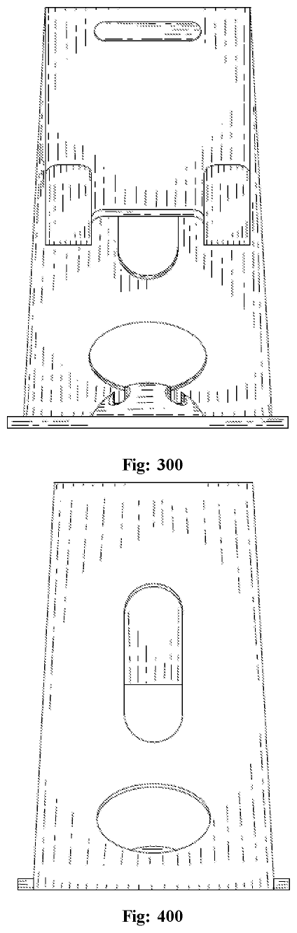

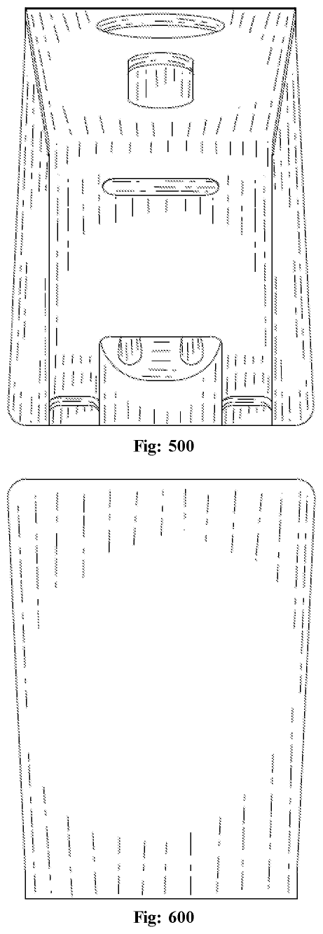

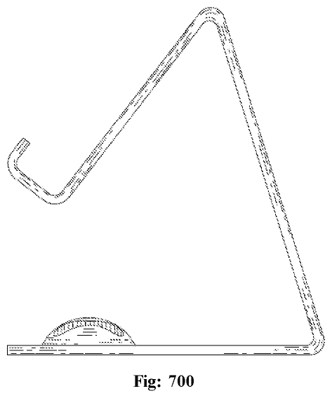

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A device that relates to a cell phone stand for supporting a phone or similar device in the upright position with an integrated cord holder.

Another embodiment of the present invention is that the device is made of the present invention provides a system permitting cell phone to be attached to a stand, allowing a user to save valuable desk space.

Another novel embodiment of the invention relates to cord included in the phone-holder.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A cell phone stand to secure a cell phone comprising cord included in the holder.

2) A stand with a cable holder system user can insert the cord of the charger into the slot for future continuous use.

3) The metal frame is strong, so it can withstand the weight of the smartphone without any problems.
